(19) United States
(12) Patent Application Publication
(10) Pub. No.: US 2026/0005256 A1
(43) Pub. Date: Jan. 1, 2026

(54) PRESSURE INDUCED TRANSITION MATERIALS FOR IMPROVED ELECTRODE SAFETY AND PERFORMANCE

(71) Applicant: American Lithium Energy Corporation, Carlsbad, CA (US)

(72) Inventors: Jiang FAN, San Diego, CA (US); Dongshe ZHANG, Carlsbad, CA (US); Linhua HU, San Marcos, CA (US)

(73) Assignee: American Lithium Energy Corporation, Carlsbad, CA (US)

(21) Appl. No.: 19/256,871

(22) Filed: Jul. 1, 2025

Related U.S. Application Data
(60) Provisional application No. 63/666,453, filed on Jul. 1, 2024.

(51) Int. Cl. H01M 4/62; H01M 4/13; H01M 10/0525

(52) U.S. Cl. CPC H01M 4/628; H01M 4/13; H01M 10/0525

(57) ABSTRACT

A battery cell may incorporate a pressure induced transition (PIT) material that undergoes a transition in response to changes in the internal pressure of the battery cell caused by the changes in the volume of the electrode in the battery cell that occur during the charging and discharging of the battery cell. The transition may include transformations that relieves the mechanical stress arising from the change in internal pressure as well as transformations that enhance the performance of the electrode. For example, the transition may include a phase change that manifests as a contraction in volume to accommodate the expansion of the electrode. This transition may also manifest as a reduction in bandgap to enhance the conductivity of the electrode. In some cases, the pressure induced transition (PIT) material may transition to provide a mechanical reinforcement of the electrode, thus limiting further changes in the volume of the electrode.

### CROSS REFERENCE TO RELATED APPLICATION

This application claims priority to U.S. Provisional Application No. 63/666,453, entitled “BATTERY CELLS WITH STRAIN-RELIEF ELECTRODES” and filed on Jul. 1, 2024, the disclosure of which is incorporated herein by reference in its entirety.

### TECHNICAL FIELD

The subject matter described herein relates generally to battery technology and more specifically to pressure induced transition materials for improving the safety and performance profiles of electrodes.

### BACKGROUND

Batteries are a form of electrochemical energy storage system in which energy is stored in the form of chemical reactions at the electrodes. This chemical energy is converted into electrical energy through a reduction oxidation (redox) reaction, a type of faradic process governed by Faraday's law. For example, during the charging and discharging of a battery cell, the faradic process (e.g., a reduction oxidation (redox) reaction) occurring at the electrode-electrolyte interface causes a transfer charge (or electrons) therebetween. When the battery cell is discharged, ions migrate from the negative electrode (or anode) to the positive electrode (or cathode) of the battery cell while electrons flow through an external circuit from the positive electrode (or cathode) to the negative electrode (or anode). Conversely, during the charging of the battery cell, ions migrate from the positive electrode (or cathode) back to the negative electrode (or anode) of the battery cell while electrons return from the negative electrode (or anode) to the positive electrode (or cathode). Electrodes are an essential component of any battery cell. The physical properties of the electrodes in a battery cell play a deterministic role in the performance of a battery cell, including its energy density, cycle life, capacity, discharge rate, and power density. Meanwhile, the physical properties of an electrode, such as electrical resistivity, specific heat capacity (cp), potential, and hardness, are contingent upon the materials forming the electrode as well as its surface topology.

### SUMMARY

Systems, methods, and articles of manufacture, including battery cells and battery cell components, are provided. In some implementations of the current subject matter, there is provided a battery cell that includes: an electrolyte; a first electrode coupled with a first current collector; a second electrode coupled with a second current collector, wherein the second electrode has an opposite polarity as the first electrode, wherein the second electrode is a composite electrode comprising an electrode active material and a pressure induced transition (PIT) material, and wherein the pressure induced transition (PIT) material undergoes a transition in response to a change in an internal pressure of the battery cell caused by a change in a volume of the electrode active material during a charging and/or a discharging of the battery cell; and a separator interposed between the first electrode and the second electrode.

In some variations of the battery cell, one or more of the following features can optionally be included in any feasible combination.

In some variations, the transition includes a contraction in a volume of the pressure induced transition (PIT) material in response to an increase in the internal pressure of the battery cell caused by an expansion of the electrode active material. The contraction in the volume of the pressure indued transition (PIT) material relieves a mechanical stress imposed against the electrode active material by at least offsetting the expansion of the electrode active material.

In some variations, the transition includes a reduction in a bandgap of the pressure induced transition (PIT) material in response to an increase in the internal pressure of the battery cell caused by an expansion of the electrode active material. The reduction in the bandgap of the pressure induced transition (PIT) material increases a conductivity of the second electrode.

In some variations, the transition includes a polymerization of the pressure induced transition (PIT) material to form a rigid, cross-linked polymer network in response to an increase in the internal pressure of the battery cell caused by an expansion of the electrode active material. The rigid, cross-linked polymer network limits further expansion of the electrode material.

In some variations, the transition include an amorphization of the pressure induced transition (PIT) material from a crystalline solid to an amorphous or glass-like structure lacking long-range order that plastically deforms to accommodate an expansion of the electrode active material.

In some variations, the pressure induced transition (PIT) material comprises β-Cu₂V₂O₇, indium titanium oxide (ITiO), lithium titanium oxide (Li₄Ti₅O₁₂, LTO), and/or potassium ferricyanide (K₃Fe(CN)₆).

In some variations, the pressure induced transition (PIT) material comprises acrylamide or another structurally related monomer of acrylamide.

In some variations, the pressure induced transition (PIT) material comprises Sc₂(WO₄)₃TiO₂, ZrW₂O₈, GeO₂, SiO₂ (quartz, cristobalite polymorphs), ZIF-8 (Zeolitic Imidazolate Framework-8), MIL-53 (Al), MOF-5 (Zn-based), GeSbTe (GST), and/or Bi₂Te₃.

In some variations, the pressure induced transition (PIT) material comprises BiNi₁₋ₓFeₓO₃, BiNiO₃, zirconium tungstate (ZrW₂O₈), (1-x)PbTiO₃₋ₓBiCoO₃ perovskites, lithium rare-earth oxides (LiRO₂, where R=rare earth elements), scandium fluoride (ScF₃), calcium titanate fluoride (CaTiF₆), calcium zirconium fluoride (CaZrF₆), and/or cobalt zirconide (CoZr₂).

In some variations, the pressure induced transition (PIT) material undergoes the transition when the change in the internal pressure of the battery cell occurs at one temperature range or when the temperature of the battery cell reaches a different temperature range.

In another aspect, there is provided a battery cell that includes: an electrolyte; a first electrode coupled with a first current collector; a second electrode having an opposite polarity as the first electrode, wherein the second electrode is coupled with a second current collector; a pressure induced transition (PIT) layer interposed between the second electrode and the second current collector, wherein the pressure induced transition (PIT) material includes a pressure induced transition (PIT) material that undergoes a transition in response to a change in an internal pressure of the battery cell caused by a change in a volume of an electrode active material forming the second electrode during a charging and/or a discharging of the battery cell; and a separator interposed between the first electrode and the second electrode.

In some variations of the battery cell, one or more of the following features can optionally be included in any feasible combination.

In some variations, the transition includes a contraction in a volume of the pressure induced transition (PIT) material in response to an increase in the internal pressure of the battery cell caused by an expansion of the electrode active material. The contraction in the volume of the pressure indued transition (PIT) material relieves a mechanical stress imposed against the electrode active material by at least offsetting the expansion of the electrode active material.

In some variations, the transition include an amorphization of the pressure induced transition (PIT) material from a crystalline solid to an amorphous or glass-like structure lacking long-range order that plastically deforms to accommodate an expansion of the electrode active material.

In some variations, the pressure induced transition (PIT) material undergoes the transition when the change in the internal pressure of the battery cell occurs at one temperature range or when the temperature of the battery cell reaches a different temperature range.

In some variations, the transition includes a polymerization of the pressure induced transition (PIT) material to form a rigid, cross-linked polymer network in response to an increase in the internal pressure of the battery cell caused by an expansion of the electrode active material. The rigid, cross-linked polymer network limits further expansion of the electrode material.

In another aspect, there is provided a battery cell that includes: an electrolyte; a first electrode coupled with a first current collector; a second electrode having an opposite polarity as the first electrode, wherein the second electrode is coupled with a second current collector; and a separator interposed between the first electrode and the second electrode, wherein the separator includes a pressure induced transition (PIT) material that undergoes a transition in response to a change in an internal pressure of the battery cell caused by a change in a volume of an electrode active material forming the second electrode during a charging and/or a discharging of the battery cell.

In some variations of the battery cell, one or more of the following features can optionally be included in any feasible combination.

In some variations, the transition includes a contraction in a volume of the pressure induced transition (PIT) material in response to an increase in the internal pressure of the battery cell caused by an expansion of the electrode active material. The contraction in the volume of the pressure indued transition (PIT) material relieves a mechanical stress imposed against the electrode active material by at least offsetting the expansion of the electrode active material.

In some variations, the transition include an amorphization of the pressure induced transition (PIT) material from a crystalline solid to an amorphous or glass-like structure lacking long-range order that plastically deforms to accommodate an expansion of the electrode active material.

In some variations, the pressure induced transition (PIT) material undergoes the transition when the change in the internal pressure of the battery cell occurs at one temperature range or when the temperature of the battery cell reaches a different temperature range.

In some variations, the transition includes a polymerization of the pressure induced transition (PIT) material to form a rigid, cross-linked polymer network in response to an increase in the internal pressure of the battery cell caused by an expansion of the electrode active material. The rigid, cross-linked polymer network limits further expansion of the electrode material.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to metal ion battery cells, such as lithium ion battery cells, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a schematic diagram illustrating an example of a battery cell, in accordance with some example embodiments;

FIG. 2 depicts a schematic diagram illustrating another example of a battery cell, in accordance with some example embodiments;

FIG. 3 depicts a schematic diagram illustrating another example of a battery cell, in accordance with some example embodiments;

FIG. 4A depicts a graph illustrating the pressure dependence of the unit cell volume of crystal BiNiO₃, in accordance with some example embodiments;

FIG. 4B depicts a graph illustrating the compressibility of cubic ZrW₂O₈ and cubic ZrMo₂O₈ under hydrostatic conditions, in accordance with some example embodiments;

FIG. 5 depicts a graph illustrating the rate profile at 0.8 A and 4 A of a baseline cell (Sicyl163-2), in accordance with some example embodiments;

FIG. 6 depicts a graph illustrating the rate Profile at 0.8 A and 4 A of a pressure induced transition (PIT) cell incorporating a pressure induced transition (PIT) material (Sicyl162-2), in accordance with some example embodiments;

FIG. 7 depicts a graph illustrating the cycle life of a baseline cell (Sicyl163-2), in accordance with some example embodiments;

FIG. 8 depicts a graph illustrating the cycle life of a baseline cell (Sicyl163-2) with the 1st and the 300th cycle profiles, in accordance with some example embodiments;

FIG. 9 depicts a graph illustrating the cycle life of a pressure induced transition (PIT) cell incorporating a pressure induced transition (PIT) material (Sicyl162-2), in accordance with some example embodiments; and

FIG. 10 depicts a graph illustrating the cycle life of a pressure induced transition (PIT) cell incorporating a pressure induced transition (PIT) material (Sicyl162-2) with the 1st and the 300th cycle profiles, in accordance with some example embodiments.

When practical, similar reference numbers denote similar structures, features, or elements.

### DETAILED DESCRIPTION

While a battery cell undergoes charging and discharging, the electrodes within the battery cell may expand and contract due to structural changes in the constituent materials. For a metal ion battery cell, such as a lithium (Li) ion battery cell, the expansion and contraction of the electrodes may accompany the insertion (e.g., intercalation) and extraction (e.g., deintercalation) of metal ions (e.g., lithium (Li) ions) from the electrodes. The expansion and contraction of the electrodes may cause the internal pressure inside the battery cell to fluctuate during charge and discharge cycles. For example, for metal or metal oxide electrodes, the constituent metal particles may undergo substantial swelling and shrinking during charge and discharge cycles. The volume of silicon (Si) particles forming the silicon-based anodes found in some lithium (Li) ion battery cells can change up to 400% during charge and discharge cycles. Excess internal pressure can be detrimental to battery capacity and cycle life, the latter being the quantity of full charge and discharge cycles a battery cell can undergo before its capacity is diminished beyond a threshold level. For instance, the metal particles in the aforementioned metal or metal oxide electrodes can deform (e.g., crack, fragment, pulverize, and/or the like) when subjected to mechanical stress from excess internal pressure. This damage to the metal particles can degrade the electrical contact between adjacent metal particles as well as the electrical contact between the electrode and the current collector coupled therewith, thus precipitating a rapid decline in battery capacity and cycle life. In more extreme cases, excess internal pressure can also pose significant safety hazards, such as when the expansion of the electrodes ruptures the case of the battery cell leading to intense fires and explosions. Accordingly, there is a compelling need for mechanisms to regulate the internal pressure within the battery cell.

Various example embodiments of the present disclosure mitigate the performance and safety hazards associated excess internal pressure by incorporating one or more pressure induced transition (PIT) materials in a battery cell. For example, in some cases, one or more electrodes of the battery cell may include a pressure induced transition (PIT) material combined with one or more electrode active materials. Alternatively and/or additionally, the battery cell may include one or more layers of the pressure induced transition (PIT) material. For instance, in some cases, a pressure induced transition (PIT) layer (or a layer of the pressure induced transition (PIT) material) may be interposed between an electrode and a corresponding current collector. As described in more details below, in some cases, the pressure induced transition (PIT) material may respond to a change in the internal pressure of the battery cell, such as an increase in pressure accompanying the expansion of one or more electrodes, by at least undergoing a phase transition (e.g., a reversible or irreversible change in volume) to absorb the mechanical stress arising from the change in internal pressure. Furthermore, in some cases, the pressure induced transition (PIT) material in its phase transitioned (e.g., shrunken, amorphous, and/or the like) state may exhibit a narrower bandgap (or energy gap) and thus improve the performance of the electrode by enhancing the electrical conductivity of the electrode.

Conventional negative thermal expansion (NTE) materials are activated when subjected to temperatures far outside of the normal temperature range of batteries (e.g., 15° C. to 35° C. for lithium (Li) ion batteries). However, conventional negative thermal expansion (NTE) materials are insensitive to pressure changes, meaning that conventional negative thermal expansion (NTE) materials will remain inactive when the changes in the internal pressure of a battery cell are not accompanied by a sufficient change in temperature. Critically, pressure changes in many common scenarios, such as those precipitated by the charging and discharging of the battery cell, transpire while the battery cell is operating within the normal temperature range. As such, conventional negative thermal expansion (NTE) materials are incapable of relieving mechanical stress and thwarting the accompanying performance and safety hazards for many common scenarios in which the internal pressure changes occur while the battery cell remains within the normal temperature range. Contrastingly, various examples of the pressure induced transition (PIT) materials described herein are sensitive to changes in the internal pressure of a battery cell even when such changes occur absent any concomitant changes in temperature. Incorporating a pressure induced transition (PIT) material therefore provides a reliable mechanism for relieving the mechanical stress created by pressure changes in a battery cell across a broader temperature range than conventional negative thermal expansion (NTE) materials.

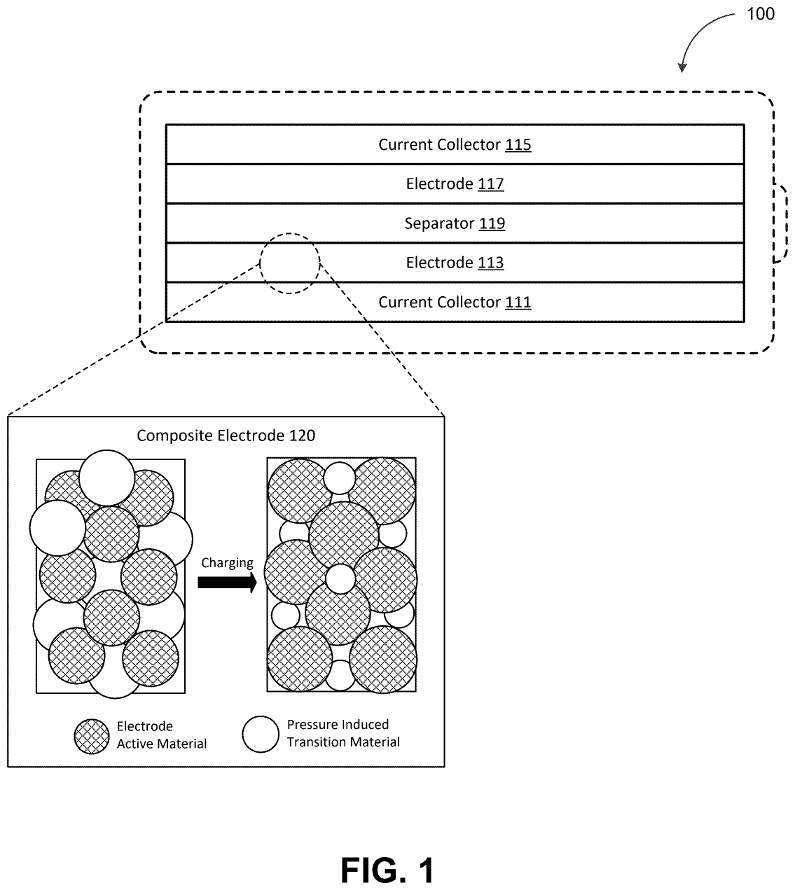

FIG. 1 depicts a schematic diagram illustrating an example of a battery cell 100, in accordance with some example embodiments. Referring to FIG. 1, in some cases, the battery cell 100 may include a first current collector 111 coupled with a first electrode 113 and a second current collector 115 coupled with a second electrode 117 having an opposite polarity as the first electrode 113. In the example of the battery cell 100 shown in FIG. 1, a separator 119 may be interposed between the first electrode 113 and the second electrode 117. Although not shown, the battery cell 100 may further include one or more electrolytes, such as an organic electrolyte, an aqueous electrolyte, a water in salt electrolyte, an ionic liquid electrolyte, a gel electrolyte, a solid electrolyte, and/or the like. In some cases, one or both of the first electrode 113 and the second electrode 117 may be a composite electrode 120 containing a pressure induced transition (PIT) material combined with one or more electrode active materials. For example, in some cases, the first electrode 113 may be the negative electrode (or anode) of the battery cell 100, which may be particularly susceptible to significant volume changes (e.g., expansion, contraction, and/or the like) during the charging and discharging of the battery cell 100 when metal ions are inserted (or intercalated) and extracted (or deintercalated) therefrom.

Referring again to FIG. 1, in some cases, the composite electrode 120 may include particles of electrode active material combined with particles of pressure induced transition (PIT) material. In some cases, the particles of pressure induced transition (PIT) material may undergo a phase transition in response to a change in pressure precipitated by a change in the volume of the particles of electrode active material. For instance, FIG. 1 shows that the charging of the battery cell 100 may trigger an increase in the volume of the particles of electrode active material, which in turn causes an increase in the internal pressure within the battery cell 100. In some cases, the particles of pressure induced transition (PIT) material may undergo a phase transition in response to this increase in internal pressure. In some cases, the phase transition may include a contraction of the particles of pressure induced transition (PIT) material, which relieves the mechanical stress imposed against the particles of electrode active material by at least offsetting the expansion in the particles electrode active material. In some cases, the phase transition may further include a narrowing of the bandgap (or energy gap) exhibited by the particles of pressure induced transition (PIT) material, which enhances the conductivity of the composite electrode 120 and, by extension, the performance of the battery cell 100.

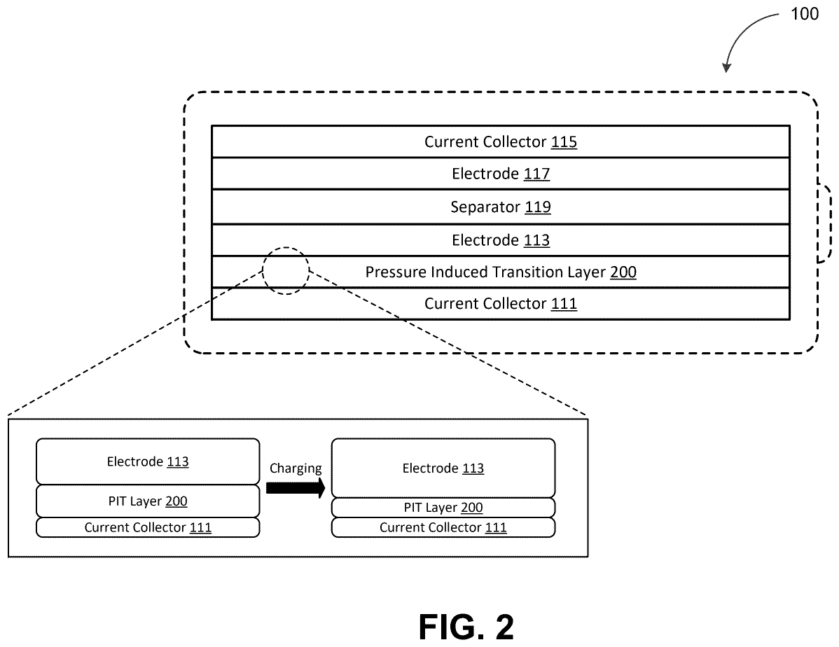

FIG. 2 depicts a schematic diagram illustrating another example of the battery cell 100, in accordance with some example embodiments. In the example of the battery cell 100 shown in FIG. 2, a pressure induced transition (PIT) layer 200 is interposed between the first current collector 111 and the first electrode 113 but it should be appreciated that the pressure induced transition (PIT) layer 200 may be disposed elsewhere in the battery cell 100 without departing from the scope of the present disclosure. In some cases, the pressure induced transition (PIT) layer 200 may undergo a phase transition in response to changes in the internal pressure of the battery cell 100. For example, FIG. 2 depicts one example scenario in which the first electrode 113 is the negative electrode (or anode) of the battery cell 100. In some cases, the first electrode 113 may expand when the battery cell 100 undergoes charging due to the constituent particles of electrode active material swelling in response to the insertion (or intercalation) of metal ions therebetween. In some cases, the expansion of the first electrode 113 may increase the internal pressure of the battery cell 100. Accordingly, as shown in FIG. 2, the pressure induced transition (PIT) layer 200 may contract in response to this increase in the internal pressure of the battery cell 100. In some cases, the contraction of the pressure induced transition (PIT) layer 200 may relieve the mechanical stress imposed against the first electrode 113 (and the constituent particles of electrode active material) by the increase in internal pressure.

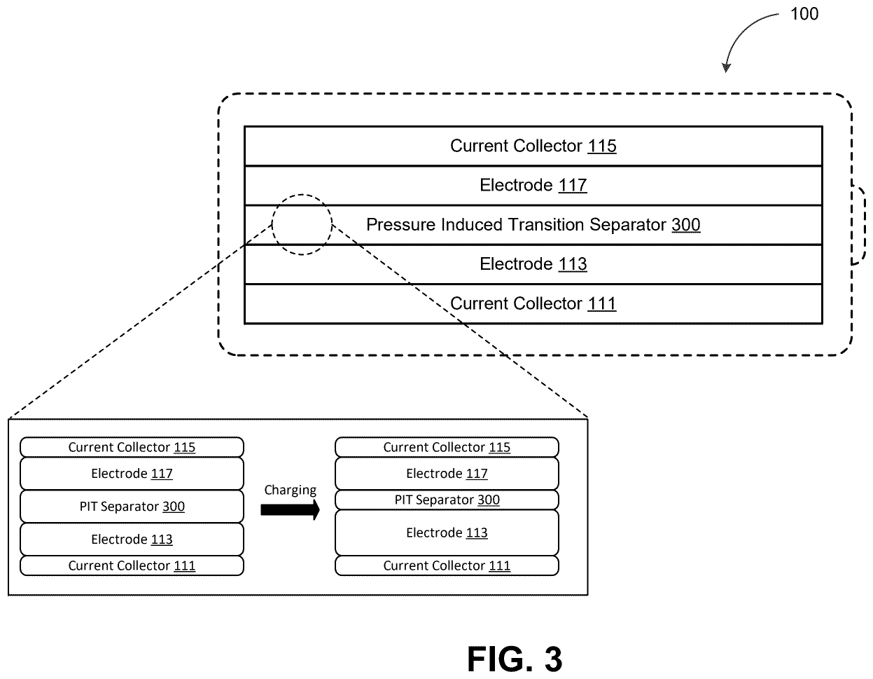

FIG. 3 depicts a schematic diagram illustrating another example of the battery cell 100, in accordance with some example embodiments. In the example of the battery cell 100 shown in FIG. 3, a pressure induced transition (PIT) separator 300 is interposed between the first electrode 113 and the second electrode 117. In some cases, the pressure induced transition (PIT) separator 300 may undergo a phase transition in response to changes in the internal pressure of the battery cell 100. For example, FIG. 3 depicts one example scenario in which the first electrode 113 is the negative electrode (or anode) of the battery cell 100. In some cases, the first electrode 113 may expand when the battery cell 100 undergoes charging due to the constituent particles of electrode active material swelling in response to the insertion (or intercalation) of metal ions therebetween. In some cases, the expansion of the first electrode 113 may increase the internal pressure of the battery cell 100. Accordingly, as shown in FIG. 3, the pressure induced transition (PIT) separator 300 may contract in response to this increase in the internal pressure of the battery cell 100. In some cases, the contraction of the pressure induced transition (PIT) separator 300 may accommodate the expansion of the first electrode 113, thus relieving the mechanical stress imposed against the first electrode 113 (and the constituent particles of electrode active material) by the increase in internal pressure.

In some example embodiments, the pressure induced transition (PIT) material forming the composite electrode 120 in the example of the battery cell 100 shown in FIG. 1, the pressure induced transition (PIT) layer 200 in the example of the battery cell 100 shown in FIG. 2, and the pressure induced transition (PIT) separator 300 in the example of the battery cell 100 shown in FIG. 3 may undergo one or more transitions when exposed to a change in the internal pressure of the battery cell 100. For example, in some cases, the volume of the pressure induced transition (PIT) material may decrease in response to an increase in the internal pressure of the battery cell 100, thereby relieving the mechanical stress generated by the expansion of the first electrode 113. Alternatively and/or additionally, the pressure induced transition (PIT) material may undergo a phase transition, such as amorphization from a crystalline solid into an amorphous or glass-like structure lacking long-range order, upon exposure to the increase in the internal pressure of the battery cell 100. In some cases, this phase transition may render the pressure induced transition (PIT) material more malleable, meaning that the pressure induced transition (PIT) material is more capable of deforming to accommodate the expansion of the first electrode 113. In some case, the aforementioned transitions (e.g., in volume, phase, and/or the like) may be accompanied by a reduction in bandgap (or energy gap). For instances, in some cases, the bandgap (or energy gap) of the pressure induced transition (PIT) material may be reduced such that the pressure induced transition (PIT) material transforms from an insulator to a conductor when the internal pressure within the battery cell 100 increases. Thus, when incorporated in the composite electrode 120, the pressure induced transition (PIT) material in its transitioned state may enhance the conductivity of the composite electrode 120.

In some example embodiments, the battery cell 100 may be a metal ion battery cell and the first electrode 113 may be a metal or metal oxide electrode. For example, in some cases, the battery cell 100 may be a lithium (Li) ion battery cell and the first electrode 113 may be a nano silicon (Si) electrode, a silicon oxide (SiO) electrode, a tin (Sn) electrode, a tin oxide (SnO) electrode, and/or the like. It should be appreciated that the normal temperature range of the battery cell 100 may be narrow (e.g., 15° C. to 35° C. for lithium (Li) ion batteries) and outside of the elevated temperature range within which conventional negative thermal expansion (NTE) materials operate. Accordingly, conventional negative thermal expansion (NTE) materials are unable to thwart the performance and safety hazards that arise when the first electrode 113 expands during the charging of the battery cell 100 at least because the temperature of the battery cell 100 charging under normal circumstances is not sufficiently high to activate conventional negative thermal expansion (NTE) materials. By contrast, various examples of pressure induced transition (PIT) materials described herein are responsive to changes in the internal pressure of the battery cell 100, with or without any concomitant changes in temperature. These pressure induced transition (PIT) materials are therefore able to provide a reliable mechanism for relieving the mechanical stress created by increased internal pressures across a broader temperature range than conventional negative thermal expansion (NTE) materials.

While some examples of the pressure induced transition (PIT) materials described herein may be responsive to both pressure changes and temperature changes, it should be appreciated that those pressure induced transition (PIT) materials are capable of responding to pressure changes that occur at a different temperature range than conventional negative thermal expansion (NTE) materials. For example, in some cases, some pressure induced transition (PIT) materials may undergo a transition when the pressure change occurs at much lower temperatures that what is necessary to activate conventional negative thermal expansion (NTE) materials. Thus, the pressure induced transition (PIT) material in the battery cell 100 may undergo a pressure induced transition while the battery cell 100 is operating within its normal temperature range, such as the case when the battery cell 100 is charging and discharging, and a temperature induced transition when the battery cell 100 encounters abnormal temperatures, such as when the battery cell 100 is experiencing thermal runaway conditions. Pressure induced transition (PIT) materials that are also sensitive to temperature, by being responsive to pressure as well as temperature fluctuations in the battery cell 100, further increases the performance, structural stability, safety profile, and longevity of the battery cell 100.

Some examples of pressure induced transition (PIT) materials described herein contract when the temperature of the battery cell 100 satisfies a first threshold (or is within one temperature range) or when the internal pressure of the battery cell 100 satisfies a second threshold but the temperature of the battery cell 100 does not necessarily satisfy the first threshold (or is in a different temperature range). Examples of such pressure induced transition (PIT) materials include BiNi₁₋ₓFeₓO₃, BiNiO₃, zirconium tungstate (ZrW₂O₈), (1-x)PbTiO₃₋ₓBiCoO₃ perovskites, lithium rare-earth oxides (LiRO₂, where R=rare earth elements), scandium fluoride (ScF₃), calcium titanate fluoride (CaTiF₆), calcium zirconium fluoride (CaZrF₆), and cobalt zirconide (CoZr₂). In some cases, pressure induced transition (PIT) materials that are responsive to a temperature trigger associated with one temperature range as well as a pressure trigger associated with a different temperature range than the temperature trigger may be particularly advantageous for accommodating the significant volumetric changes that metal or metal oxide electrodes, such as silicon (Si) anodes in lithium (Li) ion battery cells, undergo during the charging (e.g., lithiation) and discharging (e.g., delithiation) of the battery cell 100.

Some examples of pressure induced transition (PIT) materials described herein undergo amorphization, a type of phase change from a crystalline solid to an amorphous or glass-like structure lacking long-range order, when the temperature of the battery cell 100 satisfies a first threshold or when the internal pressure of the battery cell 100 satisfies a second threshold but the temperature of the battery cell 100 does not necessarily satisfy the first threshold. Examples of such pressure induced transition (PIT) materials include Sc₂(WO₄)₃TiO₂ (anatase phase)—partial pressure-induced amorphization; ZrW₂O₈—pressure-induced amorphization and negative thermal expansion; GeO₂ (germanium dioxide)—pressure-induced amorphization; SiO₂ (quartz, cristobalite polymorphs)—pressure-induced amorphization; ZIF-8 (Zeolitic Imidazolate Framework-8)—pressure-induced amorphization and porosity collapse; MIL-53 (Al)—pressure-induced amorphization with framework breathing; MOF-5 (Zn-based)—pressure-induced amorphization and structural collapse; GeSbTe (GST)—pressure-induced amorphization; and Bi₂Te₃—pressure-induced structural disorder and amorphization. Some examples of pressured induced transition (PIT) materials, such as Sc₂(WO₄)₃, may be especially advantageous due to the dual capacity to undergo amorphization under moderate pressure and contract upon heating. These synergistic behaviors may be highly desirable for buffering the significant volume changes associated with metal or metal oxide electrodes (e.g., silicon anodes in lithium (Li) ion battery cells). For example, if the battery cell 100 is a metal ion battery cell (e.g., a lithium (Li) ion battery cell) with a metal or metal oxide electrode (e.g., a silicon anode), the volumetric expansion of the metal or metal oxide particles in the electrode during charging due to the intercalation (e.g., lithiation) of the metal or metal oxide particles increases the internal pressure within the battery cell. This increase in internal pressure may induce localized amorphization in the pressure induced transition (PIT) material (e.g., Sc₂(WO₄)₃ and/or the like), which may be incorporated as a coating, a buffer layer, a composite matrix, an interfacial component, and/or the like. The amorphization of the pressure induced transition (PIT) material may enable the material to plastically deform and absorb the mechanical stress arising from the increase in internal pressure without fracturing. At the same time, the pressure induced transition (PIT) material may also contract in response to elevated temperatures, thereby offsetting thermal as well as chemical expansion of the metal or metal oxide particles forming the electrode. Accordingly, the incorporation of pressure induced transition (PIT) materials, such as Sc₂(WO₄)₃, in or around metal or metal oxide electrodes (e.g., silicon (Si) anodes in lithium (Li) ion battery cells) can suppress mechanical fracturing, maintain electrical connectivity between the metal or metal oxide particles, and reduce repeated solid electrolyte interphase (SEI) formation. The incorporation of pressure induced transition (PIT) materials that undergo amorphization when temperature of the battery cell 100 satisfies a first threshold as well as when the internal pressure of the battery cell 100 satisfies a second threshold but the temperature does not necessarily satisfy the first threshold can significantly improve the cycling stability, Coulombic efficiency, and overall lifespan of the battery cell 100 (e.g., metal ion battery cells with metal or metal oxide electrodes).

Some examples of pressure induced transition (PIT) materials described herein may, in addition to exhibiting a change in volume when exposed to changes in the internal pressure of the battery cell 100, exhibit a reduced bandgap (or energy gap) in response to the change in internal pressure. This reduction in bandgap (or energy gap) may enhance the conductivity of the metal or metal oxide electrode (e.g., silicon (Si) anode) incorporating the pressure induced transition (PIT) materials. Examples of pressure induced transition (PIT) materials that responds to pressure changes with a change in volume and in a reduction in bandgap (or energy gap) include β-Cu₂V₂O₇; indium titanium oxide (ITiO), which, upon compression-decompression treatment, forms a metastable, highly transparent phase with a conductivity increase of nearly two orders of magnitude due to an irreversible pressure-induced phase transition; -lithium titanium oxide (Li₄Ti₅O₁₂, LTO), which exhibits pressure-induced amorphization at ˜26.9 GPa. Post-amorphization impedance spectroscopy confirms a marked enhancement in conductivity, with the decompressed amorphous LTO demonstrating an order of magnitude higher conductivity compared to the pristine phase; and potassium ferricyanide (K₃Fe(CN)₆), which undergoes pressure-induced polymerization leading to improved electronic conductivity. Some examples of pressure induced transition (PIT) materials, such as β-Cu₂V₂O₇, may undergo a substantial pressure induced contraction in volume (e.g., approximately 7%), which is accompanied by a significant reduction in bandgap (or energy gap). This transformation results in enhanced electrical conductivity, rendering pressure induced transition (PIT) materials such as β-Cu₂V₂O₇ particularly suitable for both stress absorption and conductivity enhancement within metal ion battery cells (e.g., lithium (Li) ion battery cells) with metal or metal oxide electrodes (e.g., silicon (Si) anodes). Post-amorphization impedance spectroscopy confirms a marked enhancement in conductivity, with some pressure induced transition (PIT) materials such as lithium titanium oxide (Li₄Ti₅O₁₂, LTO) in their decompressed amorphous phase demonstrating an order of magnitude higher conductivity compared to the pristine phase. Accordingly, the integration of such pressure induced transition (PIT) materials into the first electrode 113 of the battery cell 100, for example, as a conductive coating, composite scaffold, or matrix filler, may serve at least two purposes: (1) mitigating stress accumulation and mechanical degradation arising from large volume changes in the metal or metal oxide particles forming the first electrode 113, and (2) establishing improved electron transport pathways to reduce internal impedance within the first electrode 113. This strategy may be particularly advantageous for high-loading metal or metal oxide electrodes, such as silicon (Si) anodes, where maintaining low impedance and mechanical cohesion is critical to extending cycle life, maintaining Coulombic efficiency, and sustaining performance under high areal capacity conditions.

Some examples of pressure induced transition (PIT) materials described herein may exhibit pressure-induced topochemical polymerization, another type of phase change that enhances the mechanical resilience of metal or metal oxide electrodes (e.g., silicon (Si) anodes) in metal ion battery cells (e.g., lithium (Li) ion battery cells). For example, acrylamide (or structurally related monomers) undergoes pressure-triggered polymerization facilitated by a hydrogen bond network. Under mechanical stress, such as that induced by the expansion of metal or metal oxide particles in an electrode during charging, acrylamide can spontaneously polymerize into polyacrylamide, thereby reinforcing the surrounding matrix structure in situ. This property enables acrylamide (and structurally related monomers) to function as a smart, stress-responsive binder system. In this approach, acrylamide (or structurally related monomers) may be incorporated into binder formulations that remain soft and pliable under low internal pressure (or low mechanical stress) conditions, which is typical early in the charging (or intercalation) cycle. As internal pressure builds during repeated charging and discharging (or intercalation and deintercalation) cycles, the monomers may undergo polymerization to form a rigid, cross-linked polymer network that limits further volumetric expansion. The polymerization creates a mechanical reinforcement to ensure that the binder remains flexible when internal pressure (or mechanical stress) is minimal and provides structural reinforcement when high internal pressure (or high mechanical stress) threatens to fracture or delaminate the electrode. In some cases, deploying a pressure induced transition (PIT) material as a binder offers several key advantages, particularly for metal or metal oxide electrodes (e.g., silicon (Si) anodes), including: (i) prevention of over-expansion and particle pulverization, (ii) suppression of repeated solid electrolyte interphase (SEI) formation, and (iii) improved electrode integrity over extended cycling. As such, incorporating a pressure induced transition (PIT) material in the battery cell 100, particularly as a pressure sensitive binder in the first electrode 113 when the first electrode 113 is a high-capacity metal or metal oxide electrode (e.g., a silicon (Si) anode and/or the like), may increase the cycle life, rate performance, and mechanical stability of the battery cell 100.

Table 1 below enumerates non-limiting examples of pressure induced transition (PIT) materials.

TABLE 1

| | Pressure | Temperature | |
|---|---|---|---|
| Material | Sensitive | Sensitive | Description |
| BiNi₁₋ₓFeₓO₃ | [symbol] | [symbol] | Dual-function PIVS & NTE; buffers |
| | | | stress and thermal expansion in Si |
| | | | anodes. |
| BiNiO₃ | [symbol] | [symbol] | Similar to BiNi1 − xFexO3; volume |
| | | | shrinkage under pressure and NTE |
| | | | behavior. |
| ZrW₂O₈ | [symbol] | [symbol] | Classic NTE material; undergoes |
| | | | amorphization under pressure. |
| (1 − x)PbTiO₃ − xBiCoO₃ | [symbol] | [symbol] | Perovskite with combined PIVS and |
| | | | NTE; enhances structural stability. |
| LiRO₂ (R = rare earth) | [symbol] (some) | [symbol] (some) | Some compositions show PIVS and |
| | | | NTE-like behavior; rare earth |
| | | | dependent. |
| ScF₃ | [symbol] | [symbol] | Framework flexibility allows both |
| | | | PIVS and NTE. |
| CaTiF₆ | [symbol] | [symbol] | Fluoride framework; potential PIVS |
| | | | and known NTE behavior. |
| CaZrF₆ | [symbol] | [symbol] | Similar to CaTiF₆ in structure and |
| | | | behavior. |
| CoZr₂ | [symbol] | [symbol] | Pressure-induced volume shrinkage; |
| | | | no reported NTE. |
| Sc₂(WO₄)₃ | [symbol] | [symbol] | PIA + NTE; highly suitable for |
| | | | absorbing stress in Si anodes. |
| TiO₂ (Anatase) | Partial [symbol] | [symbol] | Partial pressure-induced |
| | | | amorphization. No known NTE. |
| GeO₂ | [symbol] | [symbol] | PIA under moderate pressure; no |
| | | | reported NTE. |
| SiO₂ | [symbol] | [symbol] | PIA occurs; some polymorphs expand |
| (quartz/cristobalite) | | | thermally. |
| ZIF-8 | [symbol] | [symbol] | PIA and porosity collapse; useful as a |
| | | | stress buffer. |
| MIL-53 (Al) | [symbol] | [symbol] | PIA + framework flexibility |
| | | | (“breathing”); no NTE. |
| MOF-5 (Zn) | [symbol] | [symbol] | PIA + collapse; useful as a buffer but |
| | | | lacks NTE. |
| GeSbTe (GST) | [symbol] | [symbol] | PIA; used in phase-change memory. |
| | | | Not known for NTE. |
| Bi₂Te₃ | [symbol] | [symbol] | Pressure-induced disorder; enhances |
| | | | conductivity. |
| β-Cu₂V₂O₇ | [symbol] | [symbol] | PIVC + band gap narrowing; boosts |
| | | | conductivity. |
| Indium Titanium | [symbol] | [symbol] | Irreversible pressure-induced |
| Oxide (ITiO) | | | conductivity increase. |
| Li₄Ti₅O₁₂ (LTO) | [symbol] | [symbol] | PIA at ~27 GPa; decompressed |
| | | | amorphous phase has higher |
| | | | conductivity. |
| K₃Fe(CN)₆ | [symbol] | [symbol] | Pressure-induced polymerization |
| | | | improves conductivity. |
| Acrylamide | [symbol] | [symbol] | Pressure-induced polymerization |
| | | | forms mechanical-reinforcing |
| | | | polyacrylamide. |

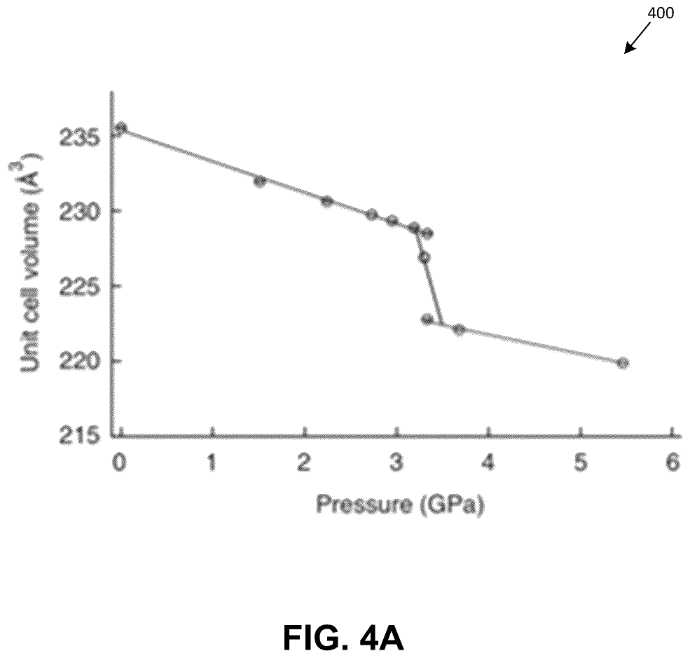

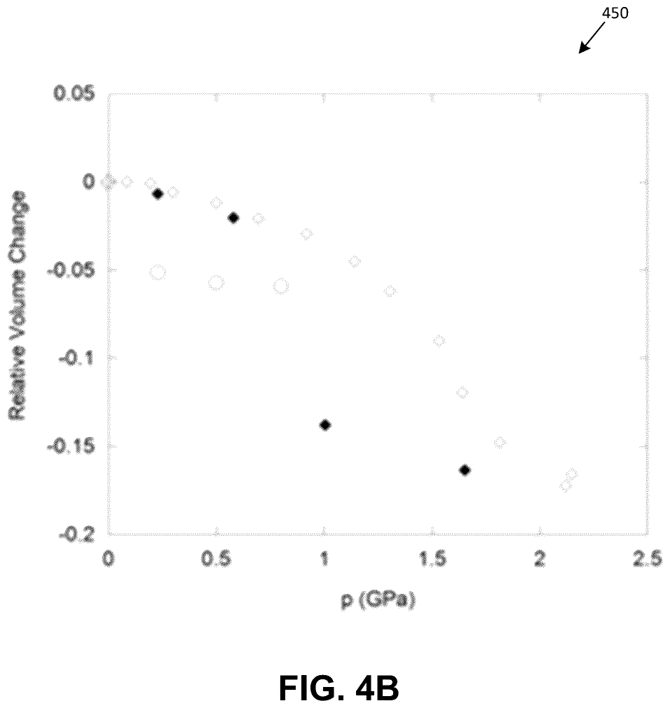

FIG. 4A depicts a graph 400 illustrating the pressure dependence of the unit cell volume of crystal BiNiO₃, in accordance with some example embodiments. As shown in FIG. 4A, crystal BiNiO₃ contracts in volume when exposed to increasing pressure, with the relationship between pressure (measured in gigapascals (GPa)) and the unit cell volume of crystal BiNiO₃ (measured in cubic angstroms (Å³)) being piecewise linear. Notably, crystal BiNiO₃ exhibits a more gradual contraction in volume when pressure is between 0 to 3 gigapascals (GPa) and when pressure is above 3.5 gigapascals. The contraction of crystal BiNiO₃ is more precipitous when pressure is between 3 to 3.5 gigapascals (GPa). FIG. 4B depicts a graph 450 illustrating the compressibility ZrW₂O₈ (denoted as circles) and cubic ZrW₂O₈ (denoted as diamonds), both of which are also examples of pressure induced transition (PIT) materials exhibiting a contraction in volume in response to an increase in pressure.

### Sample I: Baseline Cell

The positive electrode of Sample 1 was formed by dissolving a certain quantity of polyvinylidene difluoride (PVDF) in N-methylpyrrolidone (NMP) to prepare an 8% polymer solution. A certain quantity of carbon black was added to the 8% polymer solution and mixed for 30 minutes at 6500 revolutions-per-minute to form a slurry. A certain quantity of high nickel lithium nickel manganese cobalt oxide was added the slurry and mixed for 30 minutes at 6500 revolutions-per-minute with additional N-methylpyrrolidone (NMP) added for adjusting the viscosity to achieve a flowable slurry. The flowable slurry was coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample 1 was formed by compressing the aluminum (Al) foil coated with the slurry to a target thickness and cutting to a target width (e.g., 56 millimeters). A positive tab was welded to a mass free zone, for example, at the center of the positive electrode.

The negative electrode of Sample 1 was formed by dissolving a certain quantity of binder in deionized water and then a conductive additive is added and mixed for 30 minutes at 6500 revolutions-per-minute. Silicon (Si)/Silica oxide (SiO) and a carbon composite was added to the resulting solution and mixed for 60 minutes at 6500 revolutions-per-minute. Additional water was added to adjust the viscosity and form a flowable slurry. The slurry may then be coated on to a copper (Cu) foil (e.g., 9-μm thick copper foil) using an automatic coater. The negative electrode of Sample 1 was formed by compressing the copper (Cu) foil coated with the slurry to a target thickness and cutting to a target width (e.g., 58 millimeters).

The jellyroll of Sample 1 was formed by winding the positive electrode, the separator, and the negative electrode using, for example, a winding machine. The jellyroll was inserted into a case (e.g., a metal case, a soft pouch, and/or the like). One of the negative tabs was welded to the case while the positive tab was welded to the header of Sample I, for example, by laser welding. The unfinished Sample 1 was dried at 80° C. for at least 12 hours before the dried Sample I is filled with electrolyte and crimped. Sample 1 was aged for 24 hours at room temperature and before undergoing a formation process. For example, the average open circuit voltage (OCV) and impedance of Sample I at 1 kilohertz (KHz) was ˜0.85 volts and ˜40 milliohms respectively. Sample 1 was formed by being charged at C/40 with 300 milliampere hours (mAh) and then to 4.2V at the relatively high rate before being aged for 7 days at room temperature.

Sample II: Pressure Induced Transition (PIT) Cell (BiNi₁₋ₓFeₓO₃)

The positive electrode of Sample II was formed by dissolving a certain quantity of polyvinylidene difluoride (PVDF) in N-methylpyrrolidone (NMP) to prepare an 8% polymer solution. A certain quantity of carbon black was added to the 8% polymer solution and mixed for 30 minutes at 6500 revolutions-per-minute to form a slurry. A certain quantity of high nickel lithium nickel manganese cobalt oxide was added the slurry and mixed for 30 minutes at 6500 revolutions-per-minute with additional N-methylpyrrolidone (NMP) added for adjusting the viscosity to achieve a flowable slurry. The flowable slurry was coated onto an aluminum (Al) foil (e.g., 15-μm aluminum foil) using an automatic coating machine with the first heat zone set to approximately 80° C. and the second heat zone set to approximately 130° C. to evaporate the N-methylpyrrolidone (NMP). The positive electrode of Sample II may then be formed by compressing the aluminum (Al) foil coated with the slurry to a target thickness and cutting to a target width (e.g., 56 millimeters). A positive tab was welded to a mass free zone, for example, at the center of the positive electrode.

The negative electrode of Sample II was formed by dissolving a certain quantity of binder in deionized water and then a conductive additive is added and mixed for 30 minutes at 6500 revolutions-per-minute. Silicon (Si)/Silica oxide (SiO) and a carbon composite was added to the resulting solution and mixed for 60 minutes at 6500 revolutions-per-minute. A pressure-induced Negative Expansion (NE) or shrinking materials, BiNi₁₋ₓFeₓO₃ was added to the result solution and mixed for 30 minutes at 6500 revolutions-per-minute. Additional water was added to adjust the viscosity and form a flowable slurry. The slurry may then be coated on to a copper (Cu) foil (e.g., 9 μm thick copper foil) using an automatic coater. The negative electrode of Sample II was formed by compressing the copper (Cu) foil coated with the slurry to a target thickness and cutting to a target width (e.g., 58 millimeters).

The jellyroll of Sample I/II was formed by winding the positive electrode, the separator, and the negative electrode using, for example, a winding machine. The jellyroll was inserted into a case which may be, for example, a metal case, a soft pouch, and/or the like. One of the negative tabs was welded to the case while the positive tab was welded to the header of Sample I/II, for example, by laser welding. The unfinished Sample I/II was dried at 80° C. for at least 12 hours before the dried Sample I is filled with electrolyte and crimped. Sample I was aged for 24 hours at room temperature and before undergoing a formation process. For example, the average open circuit voltage (OCV) and impedance of Sample I/II at 1 kilohertz (KHz) was ˜0.85 volts and ˜40 milliohms, respectively. Sample I/II was formed by being charged at C/40 with 300 milliampere hours (mAh) and then to 4.2V at a relatively high rate before being aged for 7 days at room temperature.

The rate capability for Sample I/II were tested by the following procedure. Sample I/II was rest for 2 hours. Sample I/II was charged at a constant current and constant voltage (CC-CV) at 1.33 A (˜C/3) to 4.2 volts until <C/40, rested for 10 minutes, discharged at a constant current (CCD) at 0.8 A (˜0.2 C) to 2.5 volts, and rested for 30 minutes. Sample I/II was charged at a constant current and constant voltage (CC-CV) at 1.33 A (˜C/3) to 4.2 volts until <C/40, rested for 10 minutes, discharged at a constant current (CCD) at 4 A (˜1C) to 2.5 volts, and rested for 30 minutes. Sample 1 was charged at a constant current and constant voltage (CC-CV) at 1.33 A (˜C/3) to 3.5 volts until <C/40, rested for 10 minutes.

The cycle life at 100% depth of discharge (DoD) for Sample I/II was tested by the following procedure. Sample I/II was charged at a constant current and constant voltage (CC-CV) at 1.33 A (˜C/3) to 4.2 volts until <C/40, rested for 10 minutes, discharged at a constant current (CCD) at 4 A (˜1C) to 2.5 volts, and rested for 30 minutes. Sample Cell I was repeatedly charged and discharged for 300 cycles.

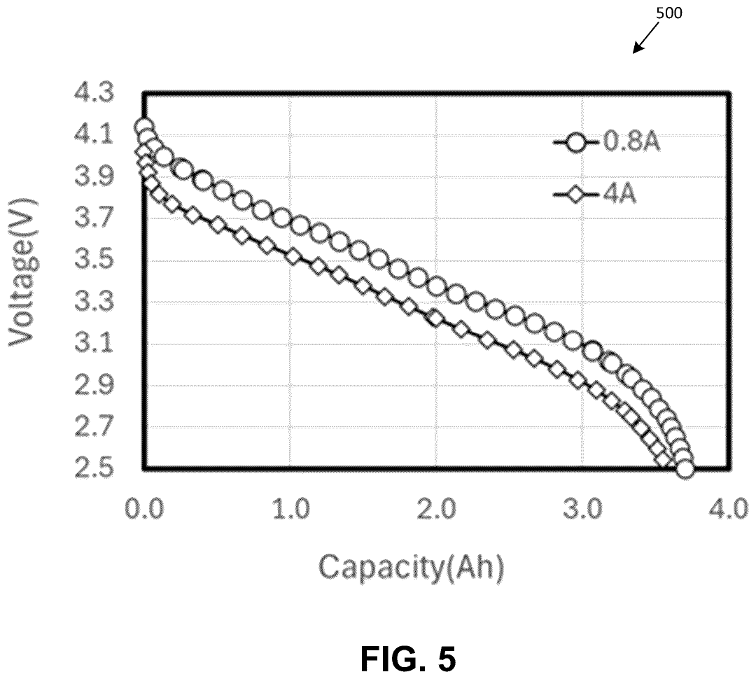

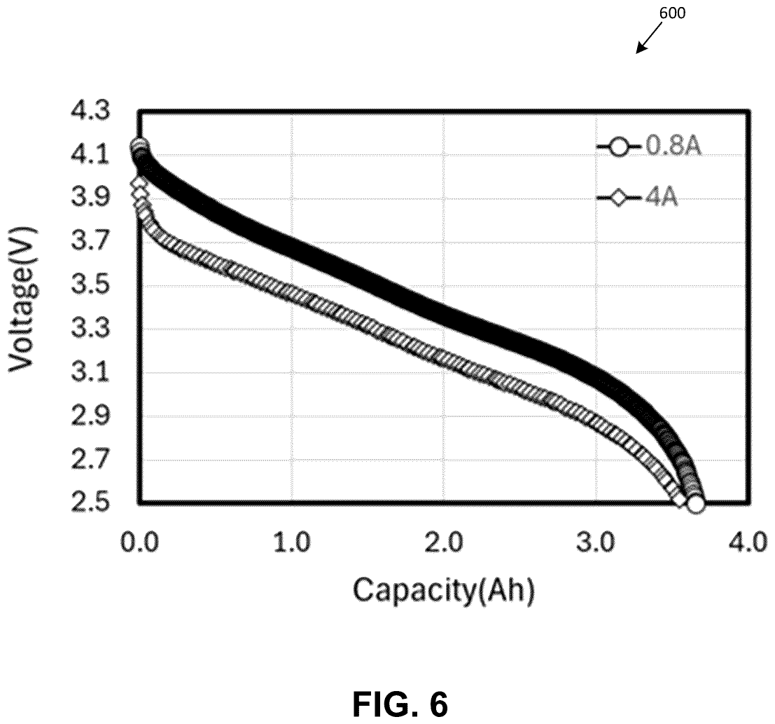

Rate capability has been tested in the baseline cell (Sample I) and the pressure induced transition (PIT) cell (Sample II). As shown in graph 500 of FIG. 5, the capacity of baseline cell Sicyl163-2 at 0.8 A and 4 A is 3.7 Ah and 3.578 Ah, with a capacity retention rate of 96.7%. As shown in graph 600 of FIG. 6, the capacity of pressure induced transition (PIT) cell Sicyl162-2 at 0.8 A and 4 A is 3.656 Ah and 3.565 Ah, with a capacity retention rate of 97.5%. While the pressure induced transition (PIT) cell exhibited a slight loss in capacity compared to the baseline cell, the pressure induced transition (PIT) cell has a better capacity retention at 1 coulomb (C). The presence of the pressure induced transition (PIT) materials is associated with improved cell rate capability.

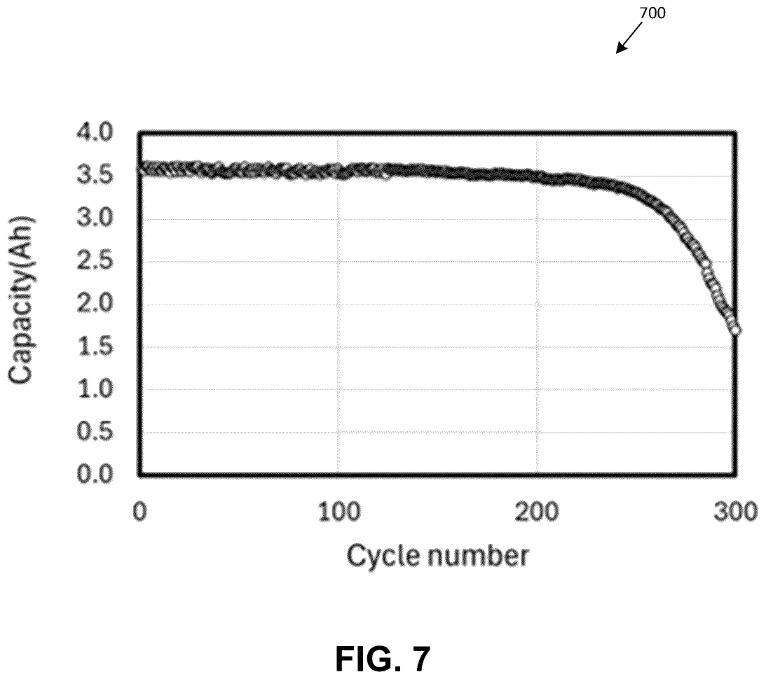

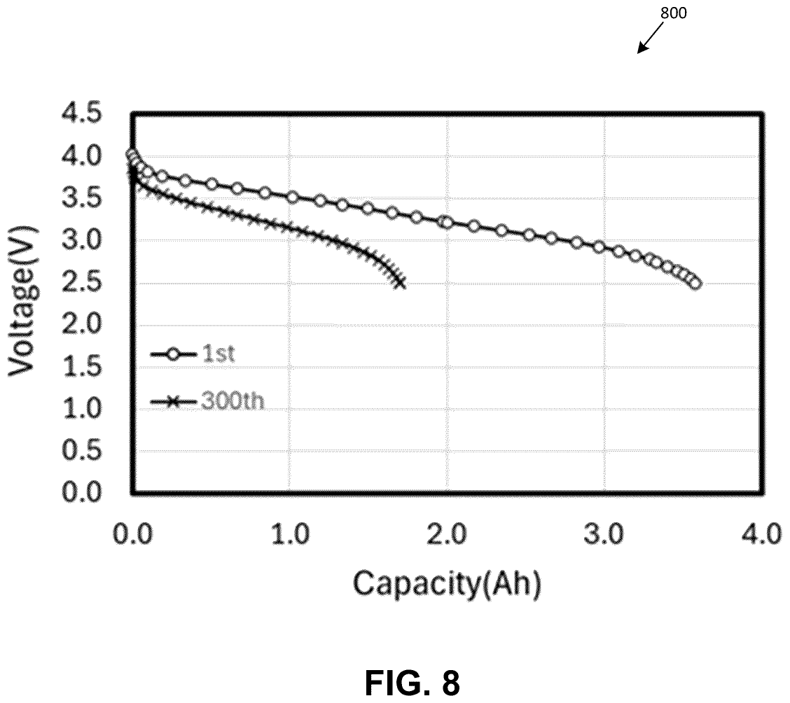

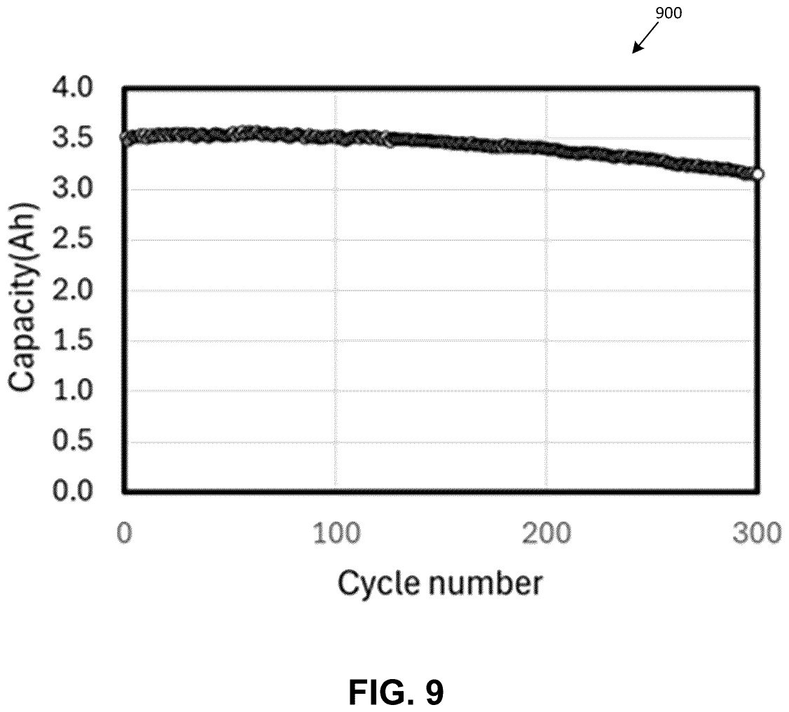

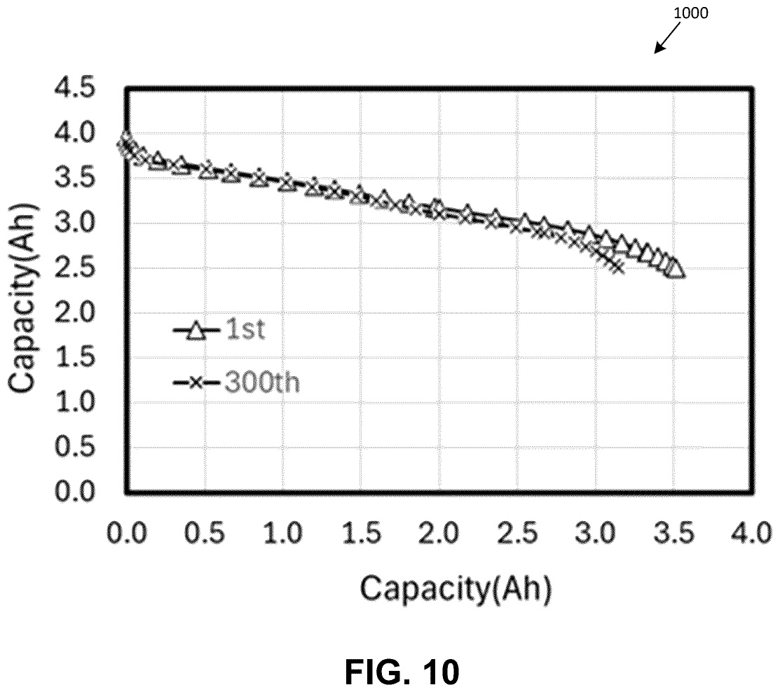

Full discharge (e.g., 100% depth of discharge (DoD)) cycle life has been tested in the baseline cell and the pressure induced transition (PIT) cell. FIG. 7 (capacity (measured in ampere hours (Ah) over successive charge and discharge cycles in graph 700) and FIG. 8 (voltage and capacity in graph 800) depict typical cycle life of the baseline cell (Sicyl163-2). As shown in FIGS. 7-8, the capacity of the baseline cell remained stable for the first 100 cycles. The capacity of the baseline cell then underwent gradual degradation from the 100th cycle the 250th cycle before degrading precipitously from the 250th cycle to 300th cycle. The capacity retention of the baseline cell is 47.7% after 300 cycles. FIG. 9 (capacity (measured in ampere hours (Ah) over successive charge and discharge cycles in graph 900) and FIG. 10 (voltage and capacity in graph 1000) depict the typical cycle life of the pressure induced transition (PIT) cell (Sicyl162-2). As shown in FIGS. 9-10, the capacity of the pressure induced transition (PIT) cell remained stable in the first 100 cycles before gradually degrading from the 100^{th} cycle to 300^{th} cycle. However, unlike the baseline cell, whose remaining capacity after the 300th cycle is merely 47.7%, the pressure induced transition (PIT) cell is able to retain 89.62% of its capacity after 300 cycles. Therefore, it should be appreciated that the degradation of the pressure induced transition (PIT) cell is much less than what is observed in the baseline cell. This is because the failure mode of the pressure induced transition (PIT) cell is different from the baseline cell, with the pressure induced transition (PIT) materials present in the negative electrode (anode) of the pressure induced transition (PIT) cell supporting a more stable solid electrolyte interphase (SEI) layer, thus providing the longer cycle life.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A battery cell, comprising:
an electrolyte;
a first electrode coupled with a first current collector;
a second electrode coupled with a second current collector, wherein the second electrode has an opposite polarity as the first electrode, wherein the second electrode is a composite electrode comprising an electrode active material and a pressure induced transition (PIT) material, and wherein the pressure induced transition (PIT) material undergoes a transition in response to a change in an internal pressure of the battery cell caused by a change in a volume of the electrode active material during a charging and/or a discharging of the battery cell; and
a separator interposed between the first electrode and the second electrode.

2. The battery cell of claim 1, wherein the transition includes a contraction in a volume of the pressure induced transition (PIT) material in response to an increase in the internal pressure of the battery cell caused by an expansion of the electrode active material, and wherein the contraction in the volume of the pressure indued transition (PIT) material relieves a mechanical stress imposed against the electrode active material by at least offsetting the expansion of the electrode active material.

3. The battery cell of claim 1, wherein the transition includes a reduction in a bandgap of the pressure induced transition (PIT) material in response to an increase in the internal pressure of the battery cell caused by an expansion of the electrode active material, and wherein the reduction in the bandgap of the pressure induced transition (PIT) material increases a conductivity of the second electrode.

4. The battery cell of claim 1, wherein the transition includes a polymerization of the pressure induced transition (PIT) material to form a rigid, cross-linked polymer network in response to an increase in the internal pressure of the battery cell caused by an expansion of the electrode active material, and wherein the rigid, cross-linked polymer network limits further expansion of the electrode material.

5. The battery cell of claim 1, wherein the transition include an amorphization of the pressure induced transition (PIT) material from a crystalline solid to an amorphous or glass-like structure lacking long-range order that plastically deforms to accommodate an expansion of the electrode active material.

6. The battery cell of claim 1, wherein the pressure induced transition (PIT) material comprises β-Cu₂V₂O₇, indium titanium oxide (ITiO), lithium titanium oxide (Li₄Ti₅O₁₂, LTO), and/or potassium ferricyanide (K₃Fe(CN)₆).

7. The battery cell of claim 1, wherein the pressure induced transition (PIT) material comprises acrylamide or another structurally related monomer of acrylamide.

8. The battery cell of claim 1, wherein the pressure induced transition (PIT) material comprises Sc₂(WO₄)₃TiO₂, ZrW₂O₈, GeO₂, SiO₂ (quartz, cristobalite polymorphs), ZIF-8 (Zeolitic Imidazolate Framework-8), MIL-53 (Al), MOF-5 (Zn-based), GeSbTe (GST), and/or Bi₂Te₃.

9. The battery cell of claim 1, wherein the pressure induced transition (PIT) material comprises BiNi₁₋ₓFeₓO₃, BiNiO₃, zirconium tungstate (ZrW₂O₈), (1-x)PbTiO₃-xBiCoO₃ perovskites, lithium rare-earth oxides (LiRO₂, where R=rare earth elements), scandium fluoride (ScF₃), calcium titanate fluoride (CaTiF₆), calcium zirconium fluoride (CaZrF₆), and/or cobalt zirconide (CoZr₂).

10. The battery cell of claim 1, wherein the pressure induced transition (PIT) material undergoes the transition when the change in the internal pressure of the battery cell occurs at one temperature range or when the temperature of the battery cell reaches a different temperature range.

11. A battery cell, comprising:
an electrolyte;
a first electrode coupled with a first current collector;
a second electrode having an opposite polarity as the first electrode, wherein the second electrode is coupled with a second current collector;
a pressure induced transition (PIT) layer interposed between the second electrode and the second current collector, wherein the pressure induced transition (PIT) material includes a pressure induced transition (PIT) material that undergoes a transition in response to a change in an internal pressure of the battery cell caused by a change in a volume of an electrode active material forming the second electrode during a charging and/or a discharging of the battery cell; and
a separator interposed between the first electrode and the second electrode.

12. The battery cell of claim 11, wherein the transition includes a contraction in a volume of the pressure induced transition (PIT) material in response to an increase in the internal pressure of the battery cell caused by an expansion of the electrode active material, and wherein the contraction in the volume of the pressure indued transition (PIT) material relieves a mechanical stress imposed against the electrode active material by at least offsetting the expansion of the electrode active material.

13. The battery cell of claim 11, wherein the transition include an amorphization of the pressure induced transition (PIT) material from a crystalline solid to an amorphous or glass-like structure lacking long-range order that plastically deforms to accommodate an expansion of the electrode active material.

14. The battery cell of claim 11, wherein the pressure induced transition (PIT) material undergoes the transition when the change in the internal pressure of the battery cell occurs at one temperature range or when the temperature of the battery cell reaches a different temperature range.

15. The battery cell of claim 1, wherein the transition includes a polymerization of the pressure induced transition (PIT) material to form a rigid, cross-linked polymer network in response to an increase in the internal pressure of the battery cell caused by an expansion of the electrode active material, and wherein the rigid, cross-linked polymer network limits further expansion of the electrode material.

16. A battery cell, comprising:
an electrolyte;
a first electrode coupled with a first current collector;
a second electrode having an opposite polarity as the first electrode, wherein the second electrode is coupled with a second current collector; and
a separator interposed between the first electrode and the second electrode, wherein the separator includes a pressure induced transition (PIT) material that undergoes a transition in response to a change in an internal pressure of the battery cell caused by a change in a volume of an electrode active material forming the second electrode during a charging and/or a discharging of the battery cell.

17. The battery cell of claim 16, wherein the transition includes a contraction in a volume of the pressure induced transition (PIT) material in response to an increase in the internal pressure of the battery cell caused by an expansion of the electrode active material, and wherein the contraction in the volume of the pressure indued transition (PIT) material relieves a mechanical stress imposed against the electrode active material by at least offsetting the expansion of the electrode active material.

18. The battery cell of claim 16, wherein the transition include an amorphization of the pressure induced transition (PIT) material from a crystalline solid to an amorphous or glass-like structure lacking long-range order that plastically deforms to accommodate an expansion of the electrode active material.

19. The battery cell of claim 16, wherein the pressure induced transition (PIT) material undergoes the transition when the change in the internal pressure of the battery cell occurs at one temperature range or when the temperature of the battery cell reaches a different temperature range.

20. The battery cell of claim 16, wherein the transition includes a polymerization of the pressure induced transition (PIT) material to form a rigid, cross-linked polymer network in response to an increase in the internal pressure of the battery cell caused by an expansion of the electrode active material, and wherein the rigid, cross-linked polymer network limits further expansion of the electrode material.
